(19) United States
(12) Patent Application Publication
(10) Pub. No.: US 2010/0276624 A1
(43) Pub. Date: Nov. 4, 2010

(54) SEAL WITH SEAL SUPPORT SHOULDER

(75) Inventors: Brandon Paul Holpuch, Twinsburg, OH (US); Christopher Michael Stiles, Avon Lake, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, Solon, OH (US)

(21) Appl. No.: 12/770,964

(22) Filed: Apr. 30, 2010

Related U.S. Application Data
(60) Provisional application No. 61/174,608, filed on May 1, 2009.

(51) Int. Cl. F16K 1/48; F16J 15/16

(52) U.S. Cl. 251/357; 277/500

(57) ABSTRACT

A seal arrangement for a fluid device includes a seal member that is disposed in a first groove formed in a body and one or more backup members disposed in a second groove formed in the body, with a shoulder between the first and second grooves against which the seal member is supported. The fluid device may be any device that contains a fluid, such as, for example, a valve, a regulator or a fluid connector. The body may be, for example, a stem-like member or other device that is disposed in a bore and for which a fluid-tight seal is needed to prevent fluid flow along the annulus between the stem and the bore wall. The shoulder may be used, for example, to provide a rigid support for the seal member under pressure, in one embodiment supporting about half of the bulk material of the seal member under pressure.

### RELATED APPLICATION

This application claims the benefit of U.S. provisional application Ser. No. 61/174,608 filed on May1, 2009, for SEAL WITH SEAL SUPPORT SHOULDER, the entire disclosure of which is fully incorporated herein by reference.

### BACKGROUND OF THE DISCLOSURE

Flow control devices such as valves, for example, typically have a translatable or rotatable actuator stem that must be sealed against fluid pressure. Other flow control devices may have one or more stems such as for end connectors that also must be sealed against fluid pressure. The stem seals may be static or dynamic depending on whether a seal member engages a surface that slides or moves against a surface of the seal member. A stem seal must perform over a desired operating range of the flow control device and at the desired pressure. However, stem seals made of elastomeric material typically are limited in their temperature performance in order to maintain rated pressure, often due to extrusion and reduced compression or squeeze along the seal surfaces.

### SUMMARY OF THE DISCLOSURE

In accordance with an embodiment of one of the inventions, a seal arrangement is provided for a fluid device of the type used to contain or control a fluid. The seal arrangement may be used with a component that is disposed in a bore wherein a fluid seal is needed between a surface of the body and the bore. The body may be an annular, cylindrical or other shaped member, examples of which include but are not limited to actuator stems, connection stems and other stem-like members. The seal arrangement may include a seal member comprising a material that is susceptible to extrusion, for example, but not limited to materials such as elastomers and plastics and other materials or composites that are not all metal.

In accordance with another embodiment of one of the inventions presented in this disclosure, a ball valve comprises a seal arrangement that prevents loss of fluid from the valve assembly along a stem. In an exemplary embodiment, a seal arrangement is provided that includes a stem seal member that is disposed in a first groove formed in the actuator stem and one or more backup members disposed in a second groove formed in the actuator stem, with a shoulder between the first and second grooves against which the stem seal is supported. In another exemplary embodiment, the support shoulder supports the seal member along a shear line that extends through a substantial bulk portion of the seal. The seal arrangement may be incorporated into many different ball valve designs with minimal modifications of the ball valve other than the stem geometric profile. The inventions will find application as well outside of the ball valve art in other applications that require stem seals. The seal arrangement may provide a dynamic seal and a static seal against fluid pressure.

In accordance with another embodiment of the inventions herein, a component or body having a surface, for example a generally cylindrical body having first diameter D1 comprises a first recess and a second recess. The first recess has a diameter D2<D1 and a the second recess has a diameter D3<D2, with a shoulder forming part of the third recess. The shoulder has an outer diameter that is approximately one-half of D1. In another embodiment, a rigid component having a surface disposed in a bore to form a space that is to be sealed under fluid pressure includes a rigid portion of the component that supports the seal along a shear line that extends through a major bulk of the seal. In a more specific embodiment, the rigid surface supports about half of the seal under pressure and a non-rigid surface supports approximately the other half of the seal. In another embodiment, a seal is disposed on a rigid member having a longitudinal axis, where in a first axial direction the rigid member supports approximately half of the seal and in a second axial direction the rigid member supports substantially all of the seal.

These and other embodiments of the inventions disclosed herein will be understood by those skilled in the art based on the following detailed description of the exemplary embodiments in view of the accompanying drawings.

### BRIEF DESCRIPTION OF THE DRAWINGS

FIG. 1 is an embodiment of a ball valve such as may be used with the present inventions;

FIG. 2 is a longitudinal cross-section of the valve of FIG. 1 taken along the line 2-2 in FIG. 1;

FIG. 3 is an enlarged illustration of a seal arrangement use in the exemplary embodiment of FIGS. 1 and 2, shown in longitudinal cross-section through the stem;

FIGS. 4 and 5 illustrate a conventional prior art stem seal arrangement under no pressure and pressure conditions respectively, shown in half-longitudinal cross-section through the stem; and

FIG. 6 illustrates in half-longitudinal cross-section the stem seal arrangement of FIG. 3 under pressure.

### DESCRIPTION OF THE EXEMPLARY EMBODIMENTS

Although the exemplary embodiments herein are presented in the context of a ball valve, the inventions herein are not limited to such applications, and will find use with many different devices for containing fluid, for example, devices that contain fluid under pressure, and which may but need not also control flow of fluid, such as valves, regulators, restrictors, couplings and so on. For example, fluid connectors are well known in the art of fluid containment, and may be used to interconnect two or more fluid devices in a fluid circuit. Fluid connectors have many different designs and configurations, but most share the common feature of a body member having an annular or generally cylindrical body surface that is disposed in a bore, with the need for a seal arrangement between the body surface and the bore to prevent fluid flow through the annulus defined between the body surface and the bore wall. Fluid connectors may use the seal arrangement as a static seal or a dynamic seal or both. By a static seal is meant that the seal member is not necessarily exposed to one or more surfaces that move relative to the engaging surface of the seal member. By a dynamic seal is meant that the seal member may be exposed to and in contact with a surface (for example, an actuator stem surface) against which it forms a seal, wherein that surface moves relative to the engaging surface of the seal member. The exemplary embodiments of a fluid connector with a seal arrangement of the present inventions are but one example of many different designs that may be used, their number being far too numerous and varied to describe or illustrate herein. Moreover, for ball valve applications, the inventions also are not limited to use with a ball valve of the exemplary design illustrated herein. Still further, an advantage of some of the embodiments herein is the provision of a seal arrangement that allows use of a softer material seal member, such as an elastomeric o-ring for example, even for fluid devices that will be exposed to wide operating temperature ranges and at significantly higher pressures than has been available prior to our inventions. However, the inventions will find application in other fluid devices that use harder seal members, and that may not have to meet higher pressure and wider temperature range performance achieved with the inventions herein.

Although the exemplary embodiments illustrate body members and stem members that are generally cylindrical or have generally cylindrical surfaces disposed in generally cylindrical bores, it is contemplated that there may be applications in which a non-cylindrical stem or body member, for example an elliptical or oval stem, may be disposed in a complementary bore and may utilize the seal arrangement concepts of one or more of the inventions herein.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

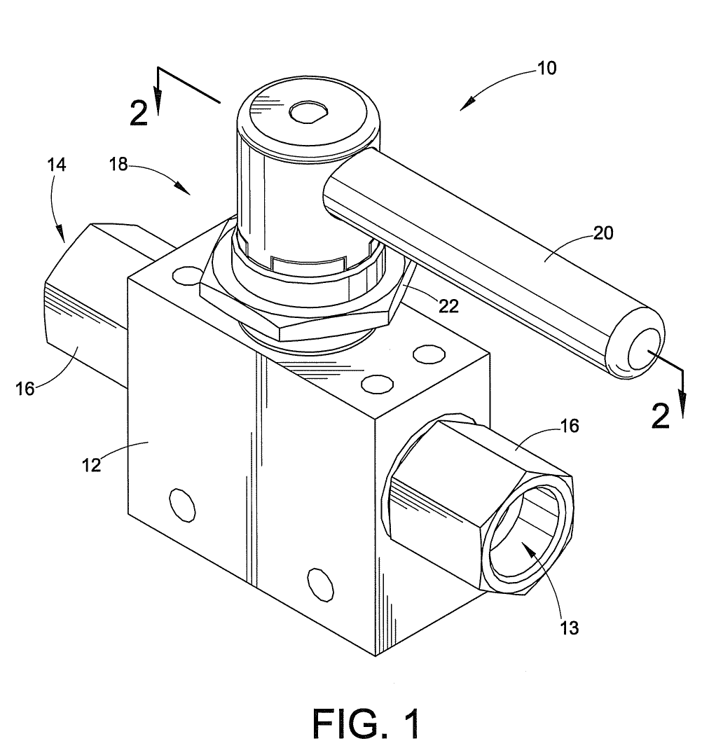

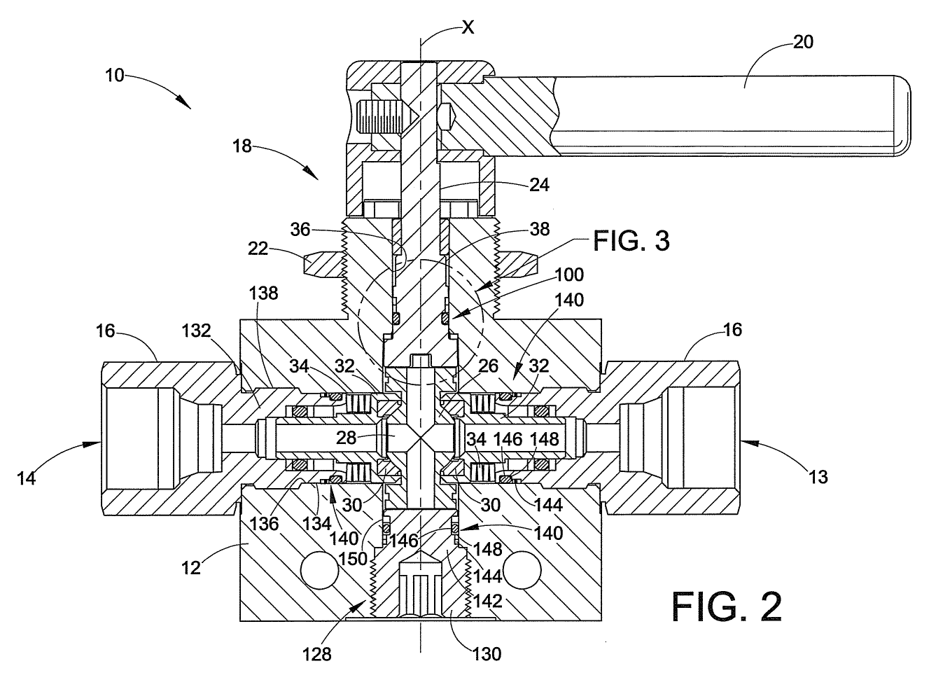

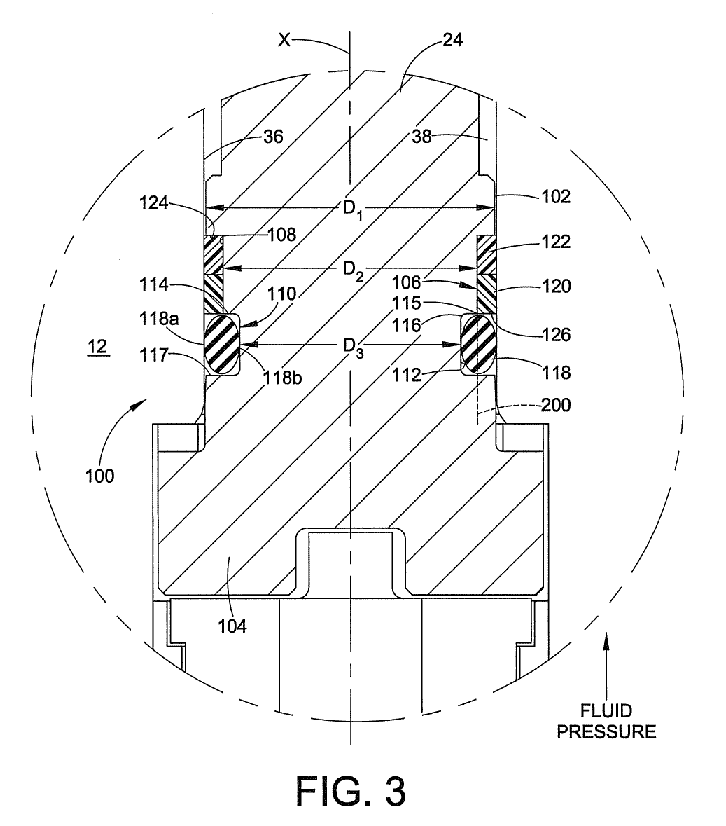

With reference to FIGS. 1 and 2, a first embodiment of one or more of the inventions is presented. In this embodiment, a fluid device 10 is illustrated that may be realized in the form of a ball valve, but many different types of fluid devices may be used as noted hereinabove, including fluid devices that do not necessarily control fluid flow. The ball valve 10 design forms no part of the present inventions other than the stem seal arrangements 100, 140 (FIGS. 2 and 3). Therefore, the ball valve 10 design will only be briefly reviewed herein, it being understood by those of ordinary skill in the art that many different ball valve designs may be used, including those presently known or later developed.

The ball valve 10 may include a valve body 12 that contains the basic valve elements. A first fluid port 13 and a second fluid port 14 provide flow ports for fluid flow through the ball valve 10. Each fluid port 13, 14 may be an inlet or an outlet, and alternatively the ball valve 10 may have more than two fluid ports. Each fluid port 13, 14 may be defined by an end connection 16 that may be used to install the ball valve 10 in a fluid line or system (not shown). The end connections 16 need not be the same.

The valve body 12 also may support a valve actuator assembly 18. In the exemplary embodiments herein, the ball valve 10 is manually actuated by means of a handle 20 or similar functioning device. Alternatively, the ball valve 10 may have a non-manual or automatic actuating device (not shown) such as an electromechanical actuator, hydraulic actuator or pneumatic actuator as is well known. The actuator assembly 18 may be securely mounted to the valve body 12 by any suitable means.

With reference to FIG. 2, the handle 20, or alternatively another actuating device, is coupled to an actuator stem 24. An actuator stem is typically, although need not be, a generally cylindrical member that extends along a longitudinal axis X, and is supported within the valve body 12 so as to be rotatable about the axis X to open and close the valve, or to otherwise adjust fluid flow through the valve. In the case of a ball valve 10, for example, the actuator stem 24 may be coupled to a ball valve element 26. The ball valve element 26 may have a through bore 28 which, when the through bore 28 is generally aligned with the fluid ports 13, 14 allows fluid flow therebetween. The ball valve 10 in FIG. 2 is illustrated in the fully open position. Seat seals 30 are commonly used to seal against fluid pressure when the ball valve element when the ball valve 10 is closed, such as for example, when the actuating device (for example the handle 20 for a manual valve) rotates the ball valve element 26 about the axis X about ninety degrees from the position illustrated in FIG. 2. The seat seals 30 may be pressed against the ball valve element 26, for example, by means of seat seal carriers 32 and springs 34.

All references herein to “axial” and “radial” are with respect to the X axis unless otherwise noted herein. Additionally, although the exemplary embodiments are described herein in terms of a stem, the inventions are equally applicable to any component surface that fits within a bore wall to require a seal (static or dynamic) against fluid pressure, with the exemplary component surface being realized in the faun of a generally cylindrical body disposed in a generally cylindrical bore. A stem is but one example of such a body but it should be understood that the inventions will find application beyond those uses that might commonly be known or understood as constituting a stem.

Various seals are provided about the ball valve element 26 to prevent loss of system fluid (the term system fluid herein refers to the fluid that is contained and controlled by the fluid device 10, including but not limited to gasses or liquids). However, it is commonly desired to also provide a seal arrangement to prevent system fluid from escaping into the actuator assembly 18 or to the ambient environment. An actuator stem, such as the actuator stem 24 herein, extends through an actuator stem bore 36 in the valve body. This stem bore 36, along with the stem 24, define an annulus or annular space 38 that is sealed against fluid loss by the seal arrangement. It is the seal arrangement that is the subject of the present inventions, whether the seal arrangement is used for an actuator stem or other stem or stem-like member, or other body disposed in a bore, and whether used as a static seal or a dynamic seal.

Turning to FIG. 3, an embodiment of a seal arrangement 100 in accordance with one or more of the inventions herein is illustrated. In this illustration, the seal arrangement 100 is illustrated in an unpressurized condition as opposed to as it would appear when exposed to higher system fluid pressure conditions (see FIG. 6). FIG. 3 is an enlarged view of the circled portion of FIG. 2. An actuator stem, such as for example for a ball valve or other fluid device, may have a very simple profile, such as a generally cylindrical shape, or may have a number of features depending on the overall ball valve design and seal requirements. Therefore, an actuator stem 24 may have a number of recesses, slots, grooves and so on. Usually, a stem seal is disposed in a recess such that the seal is compressed radially between a surrounding surface and a surface of the actuator stem. The present invention contemplates a seal and recess design that significantly improves the performance of the seal arrangement, particularly under pressure.

In the embodiment of FIGS. 2 and 3 then, the actuator stem 24 may have a radially outer surface 102 which may or may not be an outer surface of greatest diameter of the actuator stem 24. For example, in FIG. 3 it will be noted that a lower end 104 of the actuator stem 24 may have a larger diameter than the outer surface 102. The outer surface 102 closely fits within the actuator stem bore 36, and has a diameter D1.

A first recess 106 may be provided in the outer surface 102. The first recess 106 may be considered as being defined or delimited in part by a first axially extending wall 108.

The first recess 106, as defined in part by the first axially extending wall 108, has a diameter D2, such that D2<D1.

A second recess 110 may be provided that preferably but not necessarily is axially adjacent the first recess 106. The second recess 110 is disposed axially adjacent the pressure side of the first recess 106. In other words, in the preferred exemplary embodiment, the second recess 110 may be radially recessed from the first axially extending wall 108. The second recess 110 may be considered as being defined in part by a second axially extending wall 112, which typically will not be tapered radially so as to provide a good seal surface that faces the bore 36 wall. The second recess 110, as defined in part by the second axially extending wall 112 has a diameter D3, such that D3<D2<D1.

The second recess 110 preferably but not necessarily is axially adjacent the first recess 106 such that a shoulder 114 is presented between the first and second recesses 106, 110. The shoulder 114 may be a generally radial wall extending outward from the second axially extending wall 112. Alternatively, the shoulder 114 need not be along a radius but may have a taper, and also may have other shapes and contours other than as a flat surface. The shoulder 114 may join with the second axially extending wall 112 with an optional radius or other curved profile portion 116. The radius portion 116 may be selected based on the seal size, and will typically have a lower end limit of about eight-thousandths of an inch due to conventional tooling limitations. We have found that a radius of about fifteen-thousandths of an inch works well. The second recess 110 is further defined by a lower or pressure-side wall 117 that extends in a radial direction from the second axially extending wall 112. Although in the exemplary embodiments the shoulder 114 and the pressure-side wall 117 extend generally along a radius, such is not required, and these wall sections may, for example, be tapered or have other shapes and profiles as needed. Therefore, when we say that the first shoulder 114 extends “radially outward” we mean that there is a radial direction to the surface, but not requiring that the surface extends parallel to a radius.

A seal member 118 (also referred to herein as a stem seal for some embodiments) is disposed in the second recess 110. The seal member 118 may be made of any suitable material that can be compressed to seal the annulus 38 against fluid pressure so as to prevent fluid from escaping the valve or getting up into the actuator mechanism 18 (FIG. 2) or loss to ambient environment or other location in the valve assembly. The stem seal 118 may be realized, for example, in the faun of an o-ring, a quad ring or other suitable seal design and made of a material that is compatible with the fluid being contained by the fluid device. Many materials may be used, and it is contemplated that such materials will include, although not be limited to, materials that may extrude under pressure, for example, non-metal materials including soft elastomer and plastic. Examples of softer materials are elastomeric materials such as Buna-N (nitrile), VITON™, and fluoroelastomers such as FKM and perfluoroelastomers such as FFKM, but many different types of materials may be used depending on the performance requirements of the stem seal such as pressure, as well as the characteristics of the fluid. Seal members made of harder non-metal materials may alternatively be used when needed. The stem seal 118 is appropriately sized with an inside (minor) and outside (major) diameter so as to be radially compressed or squeezed between the actuator stem bore 36 wall and the second axially extending wall 112 when the actuator stem 24 is inserted into the bore 36. Typically, the major diameter of the stem seal 118 will be greater than the diameter D1. This creates seal points 118a and 118b between the second axially extending wall 112 and the bore wall 36 due to the seal member 118 being squeezed or compressed therebetween. The strength of the seal points 118a and 118b is often put in terms of the percentage squeeze applied to the seal member as compared to the seal member in its natural or relaxed condition, and preferably this squeeze is radial.

One or more non-rigid (for example, non-metal) support or back-up members 120 may be provided in the first recess 106. These support members 120 function to back up the stem seal 118 when the stem seal 118 is under pressure. In the exemplary embodiment, there is a first support ring 120 and a second support ring 122 that is disposed axially adjacent the first support ring 120. The support rings 120, 122 are well known and are commonly in the form of support rings that are stiffer and less susceptible to extrusion. Typical materials for the support rings 120, 122 include but are not limited to TEFLON™ AND PEEK™ respectively. The back up support rings 120 may be radially compressed between the actuator stem bore 36 wall and the first axially extending wall 108. The support rings 120, 122 may be appropriately sized such that they substantially fill the first recess 106 such that a second shoulder 124 that in part defines the first recess 106 provides support for the backup support rings under pressure. The backup support rings 120, 122 are used to minimize extrusion of and damage to the stem seal 118 particularly when the stem seal 118 is exposed to higher pressures. In some applications, a single back up support ring may be used, and other support ring configurations may be used, such as, for example, a chevron-style arrangement as is well known in the art.

The lower backup support ring 120 preferably although not necessarily has a lower surface 126 that is about flush with or axially aligned with the surface of the first shoulder 114. However, alternatively in some designs the support ring lower surface 126 may be slightly offset from the first shoulder 114, either somewhat recessed therefrom or extending somewhat axially beyond the first shoulder 114. The non-rigid backup ring 120 and the rigid first shoulder 114 thus will support the stem seal 118 particularly when the stem seal 118 is exposed to higher pressures. In prior stem seal designs, the backup support rings 120, 122 had to take the entire stress of the load under pressure to prevent extrusion of the stem seal 118. With the present inventions, the first shoulder 114, which is a rigid shoulder formed in the actuator stem 24, provides excellent support for the stem seal 118 and further helps reduce extrusion of the stem seal 118 under higher pressure. Since the backup support rings 120, 122 are radially compressed against the actuator stem bore 36 wall, they still help reduce extrusion and damage to the stem seal 118 even with the use of the first shoulder 114.

The first shoulder 114 extends radially outward to a terminus 115, such as a corner where the first shoulder 114 meets with the first axially extending wall 108. This is the structure for the exemplary embodiment in which the second recess 110 is axially adjacent and contiguous with the first recess 106. The length of the first shoulder 114 is therefore the approximate distance from the second axially extending wall 112 to the corner 115. We have found that preferably the first shoulder 114 may have a length of about half the radial length of the second recess 110, or in other words one-half the distance of the pressure-side wall 117. This approximate length for the first shoulder 114 will correspond to about one-half the difference between the major and minor diameters of the seal member 118 in a compressed condition such as FIG. 3. The pressure-side wall 117 axially opposite the shoulder 114 supports substantially the entire seal member 118 as contrasted with the shoulder 114. This particular embodiment uses a symmetric ring-like seal member 118 (for example, an o-ring), however, if an asymmetrical seal member is used the length of the first shoulder 114 may be adjusted accordingly. In other terms, the first shoulder length is preferably selected so that the corner 115 will contact the seal member 118 in a central body portion where the bulk of the seal material is located. When the seal member 118 is under pressure, the corner 115 will create a stress or shear line 200 at approximately one-half the distance between the inside and outside diameters of the stem seal 118. We only refer to the approximate length of the first shoulder 114 and position of the corner 115 because the extent to which the length may be varied and still function as desired will depend on many factors including but not limited to the material of the seal member 118, the shape of the seal member 118 and the shape of the first shoulder 114 as well as the profile of the corner 115. Generally though, based on how we believe the structure works, the first shoulder 114 may be of appropriate length so as to have the corner 115 contact the seal member 118 at a location where a substantial bulk of the seal member material 118 is located, especially when the seal member is exposed to fluid pressure (see for example, FIG. 6). Thus in the exemplary embodiment of a symmetric o-ring, the corner 115 contacts the seal member 118 along or near a centerline of the o-ring body about halfway between the inner and outer diameters. For asymmetric seal members or seal members having a different profile as to where the bulk of the seal member material is located, first shoulder 114 lengths of greater or less radial length may be used as needed. For example, the first shoulder 114 may extend to an end that is within a range of approximately 25% to approximately 75% of the length of the second shoulder 117, and more preferably to within a range of approximately 45% to approximately 55% of the length of the second shoulder 117, and still more preferred to a range of approximately 50% of the length of the second shoulder 117 within a few thousandths of an inch. With this preferred length for the first shoulder 114, the first shoulder 114 supports about half of the stem seal 118 against fluid pressure, with the backup rings 120, 122 providing the rest of the support. The corner 115 provides an additional good seal point against fluid pressure. The corner 115 may be a sharp corner, may have a radius or other shape and contour as needed for a particular application and seal member.

We have unexpectedly discovered that this seal arrangement of a second recess 110 and rigid support shoulder 114 remarkably and dramatically improves seal performance, especially when the seal arrangement is subjected to rather wide operating temperature ranges and elevated system pressure ranges as compared to such ranges that could be achieved previously. As an example, ball valves may be rated at temperature ranges from 0° F. to 250° F. when softer seals such as, for example, elastomeric o-rings are used for the stem seal member. Particularly at the lower temperatures, the pressure rating is kept below about 10 ksi or 10,000 psi. This is due to damage that might otherwise occur to the stem seal such as nibbling or other seal wear that may occur, for example, from seal extrusion when the seal arrangement is put through temperature cycling. The seal undergoes a natural loss of squeeze or compression at lower temperatures, and extrusion can exacerbate this effect as well as causing damage to the seal. Consequently, prior to the present inventions, valves that use softer seals would need lower pressure ratings for typical operating temperature ranges, or alternatively, would have to have a lower rated pressure for a wider temperature range.

The seal arrangement 100 on the other hand has allowed us to expose the seal (for example, but not limited to, a ball valve application) to rated pressures of about 15 ksi without observing seal member damage even for a soft seal, such as made from of Buna-N or Viton™ (FKM material), for example. We have observed an increase in test pressure performance from about 40 ksi to 75 ksi or higher without loss of seal integrity over the operating temperature ranges, for example, 0° F. to 250° F., which is a performance factor increase of 2:1 or higher (keeping in mind that rated pressure may be typically less than test pressure and burst test pressure since fluid devices may be designed with inherent safety margins of three or four to one). We have also observed, using the same seal materials, even lower temperature performance improving from approximately 15° F. down to approximately −15° F. at rated pressures of about 15 ksi. It appears that the first shoulder 114 is a major contributing factor to this improvement as it will rigidly support about half of the seal member under pressure with reduced extrusion, and also takes up some of the load that would otherwise have to be borne by the support rings 120, 122.

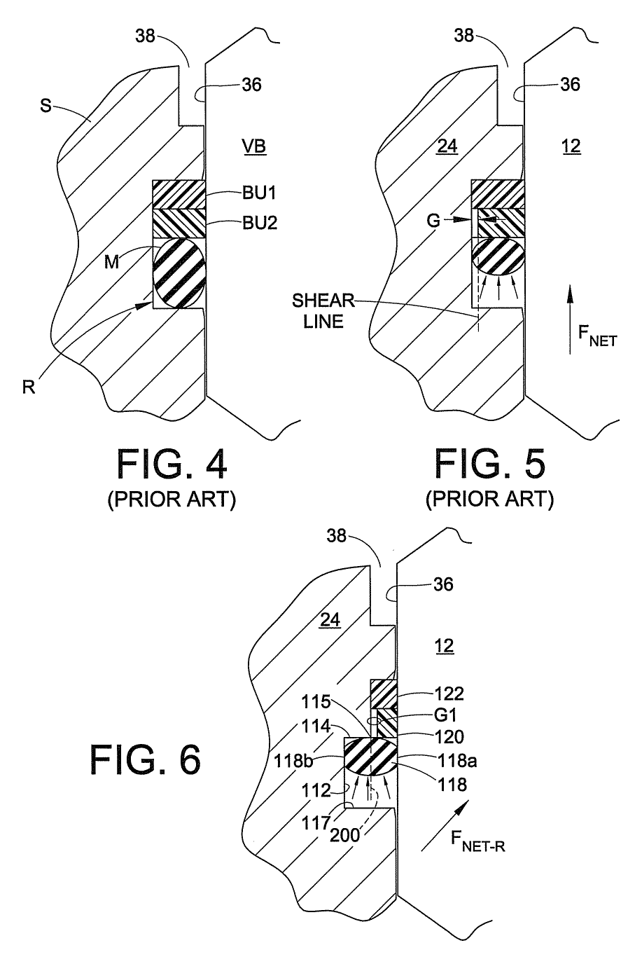

With reference to FIGS. 4-6 we now provide our best understanding of how the seal arrangement 100 works to provide such dramatic improvement in performance at wider rated temperature ranges and higher rated pressures. FIGS. 4 and 5 graphically illustrate a typical stem seal arrangement of the prior art that would be limited in rated pressure and temperature ranges. The stem S is closely fit within a bore wall 36 of the valve body VB thus presenting an annulus 38 that must be sealed against fluid pressure. The stem S includes a recess R that retains a seal member M such as a soft o-ring, and one or two back-up rings BU1 and BU2. It will be noted that the back-up rings fully support the seal member M against fluid pressure indicated by the lines FP. Under pressure, as represented in FIG. 5, the seal member M is axially compressed against the contacting back-up ring BU2 with a net force that is basically axial as indicated by the arrow F_{NET}. This is due to the fairly uniform fluid pressure applied to the seal member M and the generally symmetrical support of the back-up rings. However, as pressure increases the contacting back-up ring can radially shift or be compressed radially as shown by the gap G in FIG. 5. This gap is greatly exaggerated in size for clarity and ease of explanation for the scale size of the drawing. But note that this gap G creates a region or space that no longer supports a portion of the seal member M, thus allowing extrusion. Note further that this gap is presented near a peripheral portion of the seal member body M along a shear line denoted by the dashed line. This shear line is at a location that is near a low bulk portion of the seal material, thus increasing the extrusion under pressure. The extrusion not only can damage the seal member M but also reduces the squeeze on the seal member, which at lower temperatures is already reduced. Thus this prior art arrangement has had to be limited in temperature and pressure ratings. In other cases, the contacting back-up ring may shift or be compressed inward, but in any event the shear line will be presented in a low bulk region of the seal member body. Which way the back-up ring is compressed and where the gap G is created is somewhat unpredictable. Also known in the prior art is to use the seal member M in a groove without the back-up rings. In such an instance, under pressure the seal will be compressed against the upper shoulder where there is a small gap between the stem and the bore wall. Again, this gap not only will allow extrusion but presents a shear line that is presented in a low bulk region of the seal member body (in this case, near the outer periphery of the seal member).

Turning now to FIG. 6, under pressure the seal member 118 is axially compressed against the first shoulder 114 and the lower back-up ring 120. While the first two seal points 118a and 118b are still presented, a third seal point is made against the corner 115. This third seal point can back up the seal point 118b formed against the second axially extending wall 112 should fluid pressure get past the seal member at 118b. We believe that the support shoulder 114 results in a net fluid pressure force F_{NET-R} that is directed outward with a radial component as contrasted to the prior art. This may tend to not only strengthen the outer seal point 118a but also may contribute to the seal member 118 energizing the lower back-up ring 120 by urging the lower back-up ring 120 radially against the bore wall 36 to provide additional sealing. Moreover, this force direction is more predictable to occur as indicated, contrary to the unpredictable shift in the back-up ring of the prior art.

In addition, although a gap G1 may be presented under pressure, it is positioned near the shear line 200 at approximately the center of the pressure compressed seal member 118 where the bulk of material is located. This beefier mass of material will resist extrusion, especially at higher temperatures, substantially better than when the shear line is more towards the less mass portion of the seal body as in the prior art. With less extrusion there is less damage to the seal member 118 and also less reduction of percentage squeeze and therefore we believe contributes to the substantial improvement in temperature and pressure performance.

As noted hereinabove, the inventions may be practiced with a body member disposed in a bore other than what might be conventionally referred to in the art as a stem, including stem-like members that are not necessarily actuator stems. The body member typically will be cylindrical in a cylindrical bore, although as noted other shapes such as elliptical may be used. Many different types of devices are used to contain fluid, whether the fluid be liquid, gas or so on. Such fluid devices may be as simple as a body that provides a fluid path into or out of or within a fluid system. For example, fluid connectors are often used to connect various fluid devices together in a fluid line. Fluid connectors typically include a body having two ports for fluid flow, an in and an out. The ball valve fluid device 10 of FIG. 2 includes two such connectors 16. The valve 10 is actually illustrated as a three port valve, with a first and second port 13, 14, and an available third port 128. The third port 128 could have an end connector 16, but in this example, another type of fluid device or connector 130 is shown, commonly called a plug. The plug 130 may be used to block fluid loss from the valve when a third end connector 16 is not needed.

Each of the end connectors 16 and the plug 130 are fluid devices as that term is broadly used herein, in that they contain fluid. Moreover, such connectors typically include a generally cylindrical connector body 132 having a body surface 134, which for purposes of the seal arrangement 100 may be a surface that is analogous to the radially outer surface 102 of the actuator stem 24 in the above described actuator stem embodiment. The connector body 132 is disposed in a bore 136, and typically though need not be joined with the valve body 12 with a threaded connection 138. Because the connectors 16 contain fluid, often fluid under pressure, a seal arrangement is needed to prevent loss of fluid along the annulus defined between the bore 136 and the body surface 134. Accordingly, a seal arrangement 140 may be used for each of the connectors 16, having a similar design to the seal arrangement 100 used on the actuator stem 24, including one or more support rings 144, a seal member 146 and a shoulder 148 formed between two adjacent recesses to help support the seal member 146. Similarly, the plug 130 includes a body 142 and thus may also use a seal arrangement 140, similar to the seal arrangement 100 used on the actuator stem 24. For clarity, only some of these elements are identified with reference numerals on FIG. 2, but all three seal arrangements 140 may have the same components. The details of the seal arrangements 140 for the connectors 16 and the plug 130 are not repeated herein as the design concepts may be the same as the seal arrangement 100 for the actuator stem. However, some seal arrangements need not be the same as the others. For example, in some applications, the connectors 16 or the plug 130 might not require two support rings 144, or may use a different type of seal member 146. When a third end connector 16 is used for the third port 128 in lieu of the plug 130, the seal member 146 may be exposed to turbulence due to fluid flow in the valve. In such cases, a third support ring 150 may be used on the upstream side of the seal member 146. The third support ring 150 may prevent the seal member 146 from pulling out during blow downs or cycles (vacuum might exist during cycling causing the seal member to want to pull out). The third support ring 150 also may be used as an assist for disassembling the valve in that it can be used to prevent the seal member 146 from pulling out when the connector 130 is removed from the body.

Depending on the dimensions of the various recesses and body outer surface diameters, one or more of the support rings may be split rings to facilitate assembly.

Note that the end connectors 16 and plug 130 use what in effect are static seals in that the seal members 146 are not exposed to or seat against a moving surface. By comparison, the actuator stem seal 118 may be considered as being both a static seal when the valve actuator is stationary, or a dynamic seal in that the fluid seal made by the stem seal 118 against the second axially extending wall 112 must be maintained during rotational and/or translational movement of the stem 24. For example, actuator stems may have translational movement in diaphragm valves and thus a sliding contact between the seal member and the opposing bore wall.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A seal arrangement for a fluid device, comprising:
a body comprising a generally cylindrical surface along a longitudinal axis and adapted to be closely received in a generally cylindrical bore,
the body generally cylindrical surface having a first diameter,
a recess in the generally cylindrical surface, the recess adapted to receive a seal, the recess having an axial wall with a second diameter, the second diameter being less than the first diameter,
the recess comprising a first shoulder at a first end of the axial wall and that has a diameter that is approximately one-half the first diameter, and a second shoulder at a second end of the axial wall and that extends to the generally cylindrical surface.

2. The seal arrangement of claim 1 disposed in a generally cylindrical bore wall of a flow device to form an annulus between the generally cylindrical surface and the bore wall, and a seal disposed in the recess to provide a fluid seal against fluid pressure in the bore.

3. The seal arrangement of claim 2 wherein the seal comprises an o-ring having a major diameter in a radially uncompressed state that is greater than the first diameter.

4. The seal arrangement of claim 2 wherein the first shoulder supports approximately half of the seal when the seal is under pressure.

5. The seal arrangement of claim 2 wherein the first shoulder extends to a second axial wall to form a corner against which the seal is compressed when the seal is under pressure.

6. The seal arrangement of claim 5 wherein said corner produces a shear line in the seal that is through a substantial bulk of the seal material.

7. The seal arrangement of claim 2 comprising a back-up ring disposed between the second axial wall and the bore wall, the back-up ring supporting a portion of the seal against pressure that is not supported by the first shoulder.

8. The seal arrangement of claim 1 disposed in a ball valve, wherein the body comprises an actuator stem or a fluid connector stem in the ball valve.

9. The seal arrangement of claim 8 comprising a seal disposed in the recess, wherein the seal forms one of either a static seal or a dynamic seal.

10. The seal arrangement of claim 1 wherein the body comprises a second recess that is axially adjacent the first recess, the second recess having an axial wall that extends from the first shoulder.

11. A device for supporting a seal in a bore having a bore wall and a longitudinal axis, the device comprising:
a body disposable in the bore,
the body comprising an outer surface that faces the bore wall when the body is disposed in the bore, the outer surface having a first diameter,
a first recess formed in the body outer surface, the first recess having a second diameter, the second diameter being less than the first diameter,
a second recess formed in the body outer surface, the second recess having a third diameter, the third diameter being less than the second diameter,
the second recess being axially adjacent the first recess with a shoulder therebetween, wherein the shoulder extends to an end having a diameter that is less than the second diameter and greater than the third diameter.

12. The device of claim 11 wherein the body outer surface and the bore are generally cylindrical.

13. The device of claim 11 wherein the shoulder end extends to within a range of approximately 25% to approximately 75% of the distance between the third diameter and the first diameter.

14. The device of claim 13 wherein the shoulder end extends to within a range of approximately 45% to approximately 55% of the distance between the third diameter and the first diameter.

15. The device of claim 14 wherein the shoulder end extends to approximately 50% of the distance between the third diameter and the first diameter.

16. The device of claim 11 wherein the body is an actuator stem or a connector stem.

17. The device of claim 11 comprising a seal member disposed in the second recess, the seal member having a major diameter that is greater than the first diameter so as to seal a space presented between the body outer surface and the bore wall when the body is disposed in the bore, the shoulder supporting about half of the seal member when the seal is under pressure.

18. The device of claim 17 comprising a back-up ring disposed in the first recess, the back-up ring supporting a portion of the seal member that is not supported by the shoulder when the seal is under pressure.

19. The device of claim 18 wherein the seal member energizes the back-up ring in a radially outward direction when the seal member is under pressure.

20. The device of claim 17 wherein the shoulder forms a corner seal with the seal member when the seal member is under pressure.

21. The device of claim 20 wherein the second recess comprises a second shoulder axially spaced from the first shoulder, the second shoulder having a diameter that is approximately equal to the first diameter.
